(19) United States
(12) Patent Application Publication
(10) Pub. No.: US 2013/0208976 A1
(43) Pub. Date: Aug. 15, 2013

(54) SYSTEM, METHOD, AND COMPUTER PROGRAM PRODUCT FOR CALCULATING ADJUSTMENTS FOR IMAGES

(71) Applicant: David R. Cook, San Jose, CA (US)

(72) Inventor: David R. Cook, San Jose, CA (US)

(73) Assignee: NVIDIA CORPORATION, Santa Clara, CA (US)

(21) Appl. No.: 13/372,418

(22) Filed: Feb. 13, 2012

(51) Int. Cl. G06K 9/40; G06K 9/00

(52) U.S. Cl. 382/154; 382/254; 382/275

(57) ABSTRACT

A system, method, and computer program product are provided for calculating adjustments for images. In use, a plurality of images is identified. Additionally, one or more discrepancies are determined between the plurality of images. Further, one or more adjustments are calculated for one or more of the plurality of images, utilizing the determined one or more discrepancies.

### FIELD OF THE INVENTION

The present invention relates to stereoscopic images, and more particularly to stereoscopic image viewing.

### BACKGROUND

Stereoscopic image creation has experienced an increase in popularity. For example, digital stereoscopic cameras may be used to take three dimensional (3D) pictures. However, current techniques for implementing stereoscopic image creation and viewing have been associated with various limitations.

For example, when stereoscopic images are taken by a stereoscopic digital camera, the positioning of pixels in one portion of the stereoscopic image may not coincide with the positioning of pixels in another portion of the stereoscopic image. This may result in eyestrain while viewing the image, as a human eye may not be designed to view such errors.

There is thus a need for addressing these and/or other issues associated with the prior art.

### SUMMARY

A system, method, and computer program product are provided for calculating adjustments for images. In use, a plurality of images is identified. Additionally, one or more discrepancies are determined between the plurality of images. Further, one or more adjustments are calculated for one or more of the plurality of images, utilizing the determined one or more discrepancies.

### BRIEF DESCRIPTION OF THE DRAWINGS

FIG. 1 shows a method for calculating adjustments for images, in accordance with one embodiment.

FIG. 2 shows a method for correcting distortion within a stereoscopic image, in accordance with another embodiment.

FIG. 3 shows a method for correcting rotational distortion within a stereoscopic image, in accordance with yet another embodiment.

FIG. 4 shows an analysis and warping of a digital image, in accordance with yet another embodiment.

FIG. 5 illustrates an exemplary system in which the various architecture and/or functionality of the various previous embodiments may be implemented.

### DETAILED DESCRIPTION

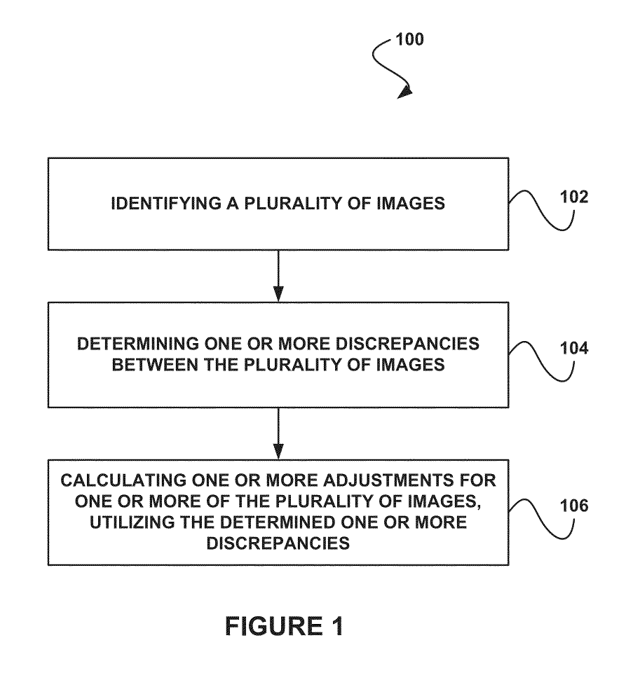

FIG. 1 shows a method 100 for calculating adjustments for images, in accordance with one embodiment. As shown in operation 102, a plurality of images is identified. In one embodiment, the plurality of images may include a pair of images (e.g., two images). In another embodiment, the plurality of images may include a pair of images that form a stereoscopic image. For example, the plurality of images may include a pair of offset images depicting the same subject matter (e.g., the same image elements, etc.), where the images may be offset horizontally and may be combined (e.g., overlayed, etc.) to create a stereoscopic image. In another example, a first image of the plurality of images may include a left image that is intended for viewing by a left eye of a user, and a second image of the plurality of images may include a right image that is intended for viewing by a right eye of the user.

Additionally, in one embodiment, the pair of images may be presented from two separate offset sources, and may be viewed by a user wearing eyeglasses that combine the separate images. In another embodiment, the pair of images may be combined and presented from a single source, and may be viewed by a user wearing eyeglasses that filter the images such that one of the images is viewed by a left eye of the user and the other image is viewed by a right eye of the user. In yet another embodiment, the pair of images may be combined and presented from a single source, and may be viewed by a user by having a light source split the images directionally into the viewer's eyes, such that one of the images is viewed by a left eye of the user and the other image is viewed by a right eye of the user without the use of eyeglasses. Of course, however, the pair of images may be viewed stereoscopically in any manner.

Further, in one embodiment, each of the plurality of images may be a digital photograph created by a camera. For example, a pair of images may be created by a digital stereoscopic camera with a pair of lenses, where each lens of the pair of lenses takes one of the pair of images. In another example, the pair of images may be created by a digital camera with a single lens, where a pair of offset images are produced using the single lens (e.g., by taking a first image with the lens, moving the location of the lens, and taking a second image with the lens). In yet another example, the pair of images may be created by a pair of digital cameras, where each digital camera has a single lens, one of the digital cameras if offset from the other digital camera, and each digital camera takes a single image, resulting in two offset images.

Further still, in one embodiment, the plurality of images may include images of a grid. For example, the plurality of images may include images of a grid including a plurality of straight vertical and horizontal lines. In another example, the images of the grid may result from taking one or more pictures of a displayed grid with a camera. For example, a grid may be displayed on a display screen (e.g., a computer monitor, a television, a cellular telephone display, etc.), may be printed on a piece of paper, may be drawn or projected onto a surface, etc., and a pair of pictures may be taken of the displayed grid, which may result in the pair of images.

Also, in one embodiment, the plurality of images may include images of a scene that includes one or more horizontal elements. For example, the images of the scene may result front taking pictures of a scene with one or more elements including horizontal lines, horizontally positioned structures, etc.

In addition, as shown in operation 104, one or more discrepancies are determined between the plurality of images. In one embodiment, the one or more discrepancies may include one or more artifacts (e.g., distortions, etc.) within one or more of the plurality of images. For example, one or more of the plurality of images may be created utilizing a camera with a lens having one or more artifacts. In another embodiment, the one or more discrepancies may include one or more areas within the plurality of images where an alignment is off (e.g., inaccurate, etc.) when the plurality of images is overlayed with each other.

In yet another embodiment, the one or more discrepancies may include one or more vertical axis positioning discrepancies. For example, the one or more discrepancies may include one or more instances where one or more elements of one image of the plurality of images do not line up along a vertical axis with the corresponding elements of another image of the plurality of images. In still another embodiment, the one or more discrepancies may include one or more rotational discrepancies. For example, the one or more discrepancies may include one or more instances where one or more elements of one image of the plurality of images are tilted or rotated with respect to the corresponding elements of another image of the plurality of images.

Further, in one embodiment, the plurality of images may include a pair of images, and the one or more discrepancies between the pair of images may include a vertical disparity between the pair of images or distortion of one or more of the images when the images are overlayed, such that one or more objects in one of the images is higher, lower, longer, or shorter than the same objects in the other image when the two images are overlayed. In another embodiment, the one or more discrepancies between the pair of images may include a magnification of one of the images when compared to the other image. For example, one image may be both higher on the top and lower on the bottom when overlayed with the other image. In yet another embodiment, the one or more discrepancies between the pair of images may result in an incorrect vertical alignment of one or more elements (e.g., objects, etc.) within a resulting stereoscopic image when the pair of images is combined to create the stereoscopic image.

Further still, in one embodiment, the one or more discrepancies may be determined by analyzing one or more of the plurality of images individually. For example, each of the plurality of images may be analyzed in order to determine whether any distortion is present within the image. For instance, if the images include pictures of a grid including a plurality of straight vertical and horizontal lines, it may be determined whether any of the images contain distorted horizontal lines horizontal grid lines (e.g., horizontal grid lines that bend upward or downward, etc.).

Also, in one embodiment, the one or more discrepancies may be determined by comparing one of the plurality of images to another of the plurality of images. For example, a pair of images may be compared to each other in order to determine whether any distortion is present between the images. For instance, if the images include pictures of horizontal elements, it may be determined whether any differences exist between the positioning of the horizontal elements within the images (e.g., whether a horizontal element in one image is positioned higher, positioned lower, larger, or smaller than the same horizontal element in another image, etc.). In this way, it may be determined whether all elements within the plurality of images line up on a horizontal plane without any vertical discrepancies.

Additionally, as shown in operation 106, one or more adjustments are calculated for one or more of the plurality of images, utilizing the determined one or more discrepancies. In one embodiment, the one or more adjustments may include parameters associated with an adjustment of the display of the one or more of the plurality of images. For example, the one or more adjustments may include instructions for adjusting one or more of the plurality of images before the one or more images are displayed.

Further, in one example, the one or more adjustments may be calculated by determining adjustments necessary to correct the one or more discrepancies between the plurality of images. For example, the one or more adjustments may be calculated by determining adjustments necessary to straighten any horizontal line within the plurality of images that are determined to be distorted. In another example, the one or more adjustments may be calculated by determining adjustments necessary to line up common elements of the plurality of images, such that the common elements are located at the same vertical location within each of the images.

Further still, in one embodiment, the one or more adjustments may include a correction of the one or more discrepancies between the plurality of images. For example, the one or more adjustments may include instructions for warping one or more of the plurality of images such that the one or more discrepancies between the plurality of images are corrected.

Also, in one embodiment, the one or more adjustments may be performed during the display of the plurality of images. For example, one or more of the plurality of images may be adjusted according to the one or more adjustments by a graphics processor (e.g., a graphics processing unit (GPU), etc.) when the graphics processor prepares the images for display (e.g., by rendering the images, overlaying the images, etc.). In addition, in one embodiment, the one or more adjustments may be provided by a camera that produces the plurality of images. For example, the camera may determine the one or more adjustments and may include the one or more adjustments within the corresponding stored image files that require the one or more adjustments.

In another embodiment, the one or more adjustments may be stored in association with one or more of the plurality of images. For example, instructions for warping one or more of the plurality of images may be stored in one or more files associated with the one or more images (e.g., the image file of the image, etc.). In yet another embodiment, the one or more adjustments may be stored in association with images other than the plurality of images. For example, the one or more adjustments may be associated with a particular camera or lens of a camera (e.g., by profiling the lens or camera, etc.) and such adjustments may be associated with all images produced using the particular camera or lens of the camera.

In this way, discrepancies between images that are overlayed to create a stereoscopic image may be adjusted to correct the discrepancies, such that when the resulting stereoscopic image is displayed, the images may be correctly aligned and precisely positioned, and user eyestrain may be reduced. Additionally, a camera lens may be profiled, and any discrepancies in images taken using the camera lens may be automatically adjusted, using the profile.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

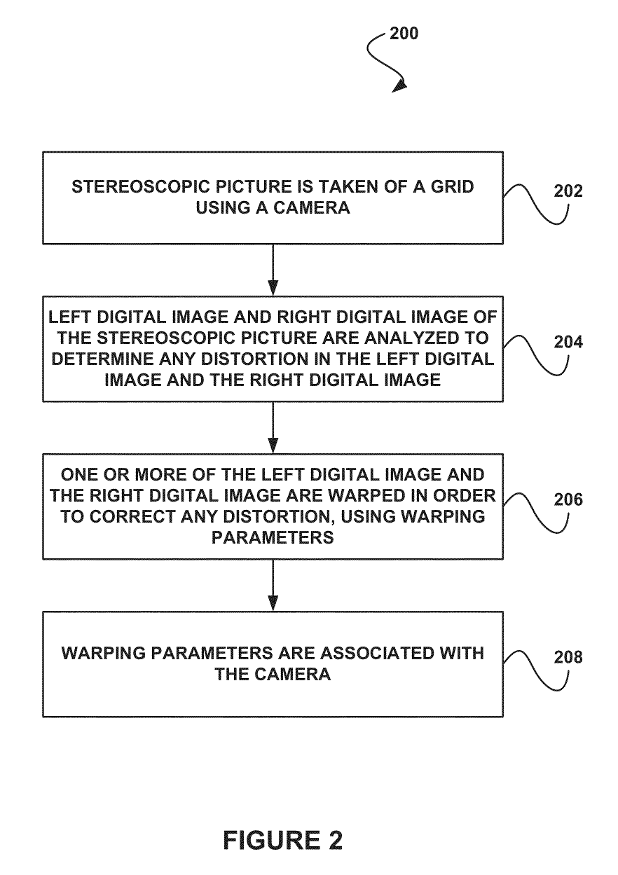

FIG. 2 shows a method 200 for correcting distortion within a stereoscopic image, in accordance with another embodiment. As an option, the method 200 may be carried out in the context of the functionality of FIG. 1. Of course, however, the method 200 may be implemented in any desired environment. It should also be noted that the aforementioned definitions may apply during the present description.

As shown in operation 202, a stereoscopic picture is taken of a grid using a camera, where the stereoscopic picture includes a left digital image of the grid and a right digital image of the grid. In one embodiment, the left digital image and the right digital image may be combined to form the stereoscopic picture. For example, the left digital image may be overlayed onto and horizontally offset from the right digital image to create the stereoscopic picture. In another embodiment, the right digital image may be overlayed onto and horizontally offset from the left digital image to create the stereoscopic picture. In yet another embodiment, the grid may be composed of evenly spaced, perfectly straight, perfectly vertical and horizontal lines. In still another embodiment, the stereoscopic picture may be taken with a three-dimensional (3D) camera and may be transferred to a computer.

Additionally, as shown in operation 204, the left digital image and the right digital image of the stereoscopic picture are analyzed to determine any distortion in the left digital image and the right digital image. In one embodiment, the straight vertical and horizontal lines in the grid may be analyzed to determine if any of the lines appear distorted (e.g., bent, crooked, etc.). In another embodiment, the analysis maybe performed by a computer program running on the computer.

Further, as shown in operation 206, one or more of the left digital image and the right digital image are warped in order to correct the correct any distortion, using warping parameters. In one embodiment, one or more of the left digital image and the right digital image may be warped during the display of the stereoscopic image. For example, one or more of the left digital image and the right digital image may be warped by a program associated with a display before the stereoscopic image is displayed utilizing the display. In another embodiment, the warping parameters may be associated with a particular region of the left digital image and the right digital image (e.g., a region delineated by lines of the grid, etc.).

Further still, as shown in operation 208, the warping parameters are associated with the camera. In one embodiment, the warping parameters may be associated with the body of the camera, one or more lenses of the camera, the entire camera, etc. In another embodiment, the warping parameters may be associated with one or more of the left digital image, the right digital image, and the digital stereoscopic picture. In yet another embodiment, the warping parameters may be associated with the camera by storing the warping parameters on the computer and associating the warping parameters with all images produced by the camera that are received by the computer (e.g., by saving the warping parameters within the image files received by the computer, etc.).

Also, in one embodiment, the warping parameters may be used to correct stereoscopic pictures received at the computer from the camera. For example, when a new stereoscopic picture is received from the camera, the computer may identify the stereoscopic picture as being associated with the camera, and may include the warping parameters associated with the camera within the stereoscopic picture file. In another example, the computer may include the warping parameters associated with the left digital image within the left digital image file of the stereoscopic picture file, and may include the warping parameters associated with the right digital image within the right digital image file of the stereoscopic picture file.

In another embodiment, the warping parameters may then be used by the computer by a processor of the computer, a program of the computer, a display of the computer, etc.) to correct any distortion in the stereoscopic picture before the stereoscopic picture is displayed. In yet another embodiment, the left digital image and the right digital image may be analyzed within the camera that took the digital images, and the camera may adjust according to the analysis and may automatically attach the warping parameters to pictures taken by the camera. In this way, the viewing of the stereoscopic image may be improved by eliminating vertical misalignment, thereby reducing viewer eyestrain.

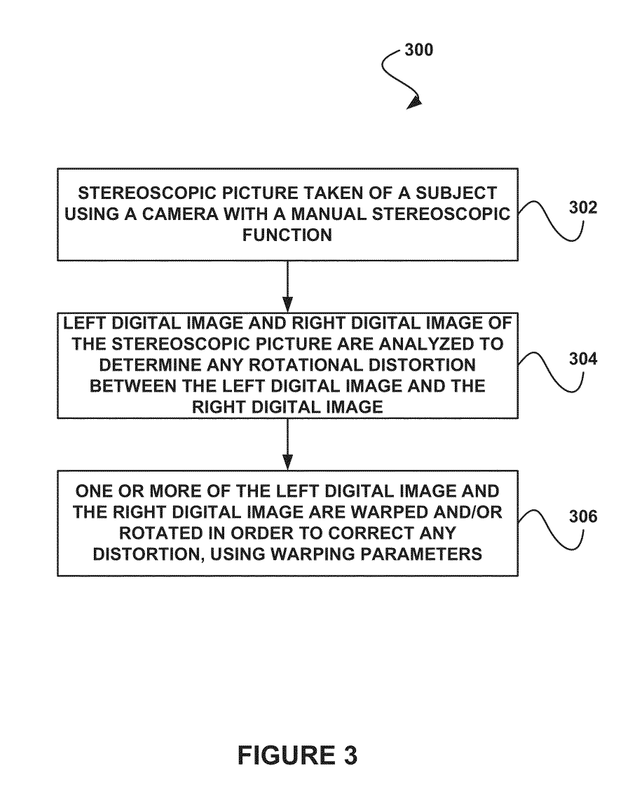

FIG. 3 shows a method 300 for correcting rotational distortion within a stereoscopic image, in accordance with another embodiment. As an option, the present method 300 may be carried out in the context of the functionality of FIGS. 1 and 2. Of course, however, the method 300 may be implemented in any desired environment. It should also be noted that the aforementioned definitions may apply during the present description.

As shown in operation 302, a stereoscopic picture is taken of a subject using a camera with a manual stereoscopic function, where the stereoscopic picture includes a left digital image of the subject and a right digital image of the subject. For example, a user of the camera may first take the left digital image of the subject, then move the camera to a slightly different position, and then take the right digital image of the subject.

Additionally, as shown in operation 304, the left digital image and the right digital image of the stereoscopic picture are analyzed to determine any rotational distortion between the left digital image and the right digital image. In one embodiment, the left digital image may be compared to the right digital image to determine if any rotational discrepancies exist between the left digital image and the right digital image (e.g., instances where one or more elements in the left digital image are rotated with respect to the right digital image, etc.). In another embodiment, the one or more horizontal lines may be identified within the left digital image and the right digital image, and any distortion between the position of a horizontal line of the left digital image and the matching horizontal line of the right digital image may be identified.

Further, as shown in operation 306, one or more of the left digital image and the right digital image are warped and/or rotated in order to correct any rotational distortion in the left digital image and the right digital image, using warping parameters that are stored within the stereoscopic picture. In this way, rotational distortion within the stereoscopic picture may be corrected.

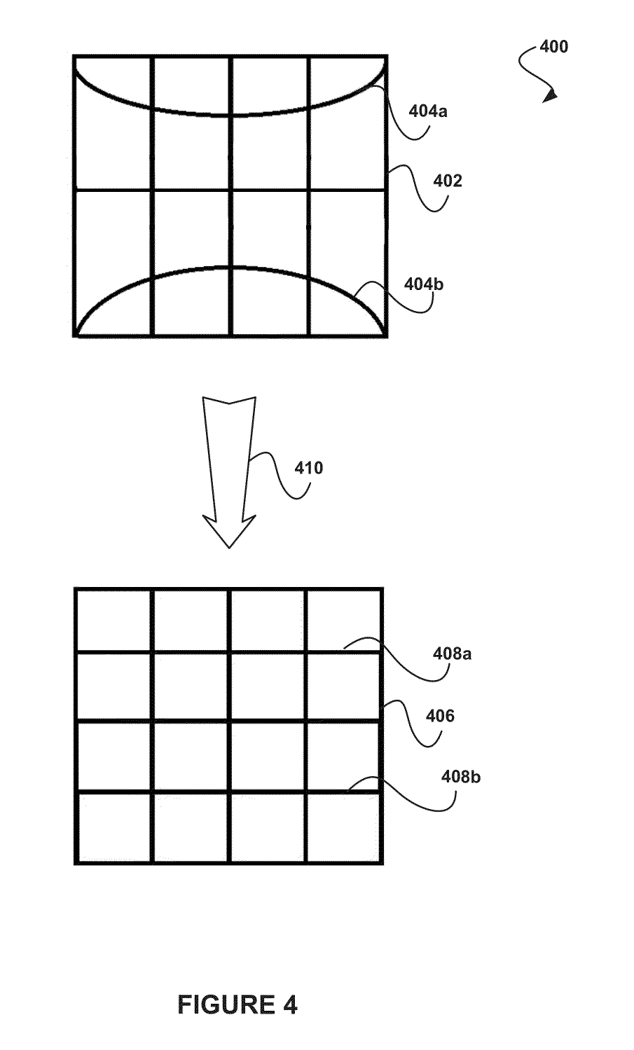

FIG. 4 illustrates an analysis and warping 400 of a digital image, in accordance with another embodiment. As an option, the present analysis and warping 400 may be carried out in the context of the functionality of FIGS. 1-3. Of course, however, the analysis and warping 400 may be implemented in any desired environment. It should also be noted that the aforementioned definitions may apply during the present description.

As shown, a distorted image 402 is presented before analysis and correction. In one embodiment, the distorted image 402 may be part of a stereoscopic image. For example, the distorted image 402 may include a left digital image of a stereoscopic picture or a right digital image of a stereoscopic picture. In another embodiment, the distorted image 402 may include the result of a stereoscopic camera taking a picture of a perfectly straight grid, where the perfectly straight horizontal and vertical lines of the grid are evenly spaced, and where the horizontal lines of the grid intersect the vertical lines of the grid at a 90 degree angle.

Additionally, the distorted image 402 includes distorted lines 404a and 404b. In one embodiment, the distorted lines 404a and 404b may result from one or more artifacts (e.g., defects, etc.) in a lens of the camera that took the picture of the perfectly straight grid and produced the distorted image 402. Also, analysis and warping 410 are performed on the distorted image 402 to create a warped image 406 that correct for the original distortion.

Further, in one embodiment, the analysis and warping 410 may include identifying and correcting the distorted lines 404a and 404b in the distorted image 402. For example, the analysis and warping 410 may include warping the distorted image 402 such that the distorted lines 404a and 404b appear as warped lines 408a and 408b. In another embodiment, the warped lines 408a and 408b may be evenly spaced and perfectly straight, and may intersect at a 90 degree angle, as in the perfectly straight grid.

Further still, in one embodiment, details associated with the warping performed during the analysis and warping 410 may be associated with a camera that produced the distorted image 402, such that future images taken by the camera can be corrected using the warping details. In this way, regions within the distorted image 402 that would be misaligned while displaying the distorted image 402 as part of a stereoscopic image may be warped using the details, such that the regions are no longer distorted in the warped image 406. Additionally, in one embodiment, the details associated with the warping performed during the analysis and warping 410 may include distortion correction information that may be stored within the distorted image 402 such that the warping may be performed on the distorted image 402 by an image viewer application at display time using the distortion correction information to create the warped image 406.

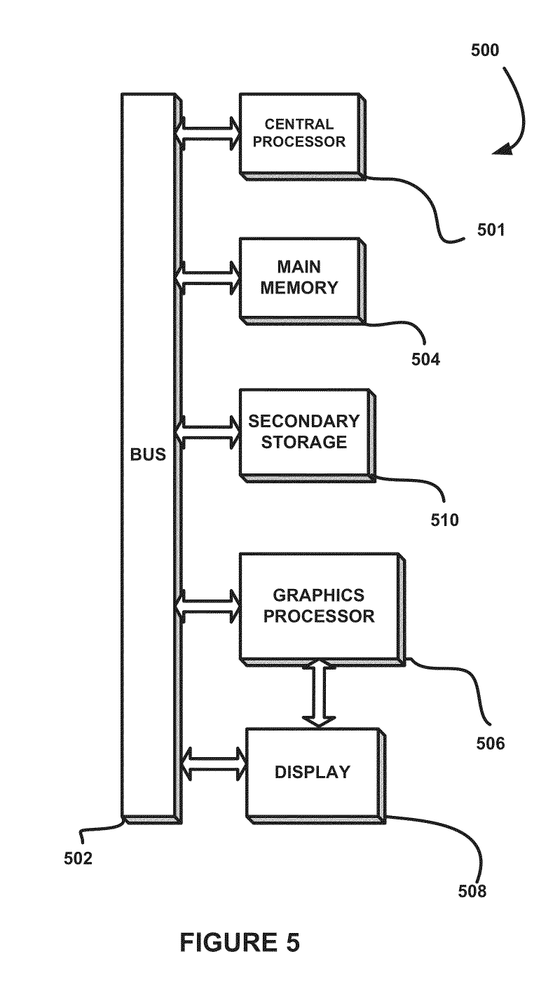

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices m including, but not limited to a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a plurality of images;
determining one or more discrepancies between the plurality of images; and
calculating one or more adjustments for one or more of the plurality of images, utilizing the determined one or more discrepancies.

2. The method of claim 1, wherein the plurality of images include a pair of images that form a stereoscopic image.

3. The method of claim 2, wherein the pair of images are created by a digital stereoscopic camera with a pair of lenses, where each lens of the pair of lenses takes one of the pair of images.

4. The method of claim 2, wherein the pair of images are created by a digital camera with a single lens, where a pair of offset images are produced using the single lens by taking a first image with the lens, moving the location of the lens, and taking a second image with the lens.

5. The method of claim 1, wherein the plurality of images include images of a grid including a plurality of straight vertical and horizontal lines.

6. The method of claim 5, wherein the images of the grid result from taking one or more pictures of a displayed grid with a camera.

7. The method of claim 1, wherein the one or more discrepancies include one or more distortions within one or more of the plurality of images.

8. The method of claim 1, wherein the one or more discrepancies include one or more areas within the plurality of images where an alignment is inaccurate when each of the plurality of images is overlayed with each other.

9. The method of claim 1, wherein the one or more discrepancies include one or more instances where one or more elements of one image of the plurality of images do not line up along a vertical axis with the corresponding elements of another image of the plurality of images.

10. The method of claim 1, wherein the one or more discrepancies include one or more instances where one or more elements of one image of the plurality of images are tilted or rotated with respect to corresponding elements of another image of the plurality of images.

11. The method of claim 1, wherein the one or more discrepancies between the plurality of images includes a magnification of one of the plurality of images when compared to another of the plurality of images.

12. The method of claim 2, wherein the one or more discrepancies between the pair of images result in an incorrect vertical alignment of one or more elements within the resulting stereoscopic image when the pair of images is combined to create the stereoscopic image.

13. The method of claim 1, wherein each of the plurality of images is analyzed in order to determine whether any distortion is present within the image.

14. The method of claim 1, wherein the images include pictures of a grid including a plurality of straight vertical and horizontal lines, and it is determined whether any of the images contain distorted horizontal lines horizontal grid lines.

15. The method of claim 1, wherein the one or more adjustments include instructions for adjusting one or more of the plurality of images before the one or more images are displayed.

16. The method of claim 1, wherein the one or more adjustments are calculated by determining adjustments necessary to correct the one or more discrepancies between the plurality of images.

17. The method of claim 1, wherein the one or more adjustments include instructions for warping one or more of the plurality of images such that the one or more discrepancies between the plurality of images are corrected.

18. The method of claim 17, wherein instructions for warping one or more of the plurality of images are stored in one or more files associated with the one or more images.

19. A computer program product embodied on a computer readable medium, comprising:
code for identifying a plurality of images;
code for determining one or more discrepancies between the plurality of images; and
code for calculating one or more adjustments for one or more of the plurality of images, utilizing the determined one or more discrepancies.

20. A system, comprising:
a processor for identifying a plurality of images, determining one or more discrepancies between the plurality of images, and calculating one or more adjustments for one or more of the plurality of images, utilizing the determined one or more discrepancies.

21. The system of claim 20, further comprising memory coupled to the processor via a bus.
